(19) United States
(12) Patent Application Publication
(10) Pub. No.: US 2015/0143267 A1
(43) Pub. Date: May 21, 2015

(54) SYSTEM AND METHOD FOR DEVELOPING A RULE-BASED EVENT-DRIVEN MULTI-LAYERED FRONTEND FOR BUSINESS SERVICES AND RENDERING THE GUIs ON MULTIPLE CLIENT DEVICES

(71) Applicant: Nuwafin Holdings Ltd, Al-Qusais (UA)

(72) Inventor: NANDAKUMAR KRISHNAN NAIR, DUBAI (UA)

(73) Assignee: Nuwafin Holdings Ltd, Al-Qusais (UA)

(21) Appl. No.: 14/082,215

(22) Filed: Nov. 18, 2013

(51) Int. Cl. G06F 3/0484

(52) U.S. Cl. CPC G06F 3/0484
USPC 715/762

(57) ABSTRACT

The various embodiments herein provide a method and system for building a Graphical User Interface (GUI) based front-end for a business service. The method comprises of selecting a user interface (UI) theme for a business solution, selecting a business service contract to be exposed through the GUI, identifying a page template to be used, configuring a page layout to expose functionalities of a business service, selecting a client device type, generating a frontend script for a plurality of client device configurations, testing the frontend scripts through one or more device-specific emulators and storing the generated frontend scripts. The frontend scripts for the plurality of client device configurations are automatically generated without coding using visual modelling tools.

### BACKGROUND

1. Technical Field

The embodiments herein generally relate to business processes and particularly relate to a mechanism to expose the functionalities of a business service to a user. The embodiments herein more particularly relates to a Service Oriented Architecture (SOA) and Graphical User Interface (GUI) technologies adapted to expose the functionalities of business services built using SOA design principles and the concept of a client-platform continuum.

2. Description of the Related Art

Generally, Service-Oriented Architecture (SOA) is a set of principles and methodologies for designing and developing software in the form of interoperable services. These services are well-defined business functionalities that are built as software components that can be reused for different purposes.

A business service contract expresses meta-information about a service. The fundamental part of a service contract consists of the service description that expresses its technical interface, essentially establishing an API into the functionality offered by the service.

The Graphical User Interface (GUI) represents the information and actions available to a user through graphical icons and other visual indicators, as opposed to text-based interfaces, typed command labels or text navigation.

The GUI models the frontend, which is responsible for collecting input in various forms from the user and processing it to conform to a specification which the back end can use. The frontend can be rendered on multiple client devices such as browsers, mobile phones, tablets etc. where the client types further vary in terms of their operating system, browser software, screen size etc.

The platform exposes the business services which have been architected using the SOA paradigm. The client needs to connect to the platform and serves as a GUI exposing the business service functionality to the user.

Hence, there is a need for a system and method for a mechanism to expose business service functionalities over a Graphical User Interface. There is also a need for a mechanism which enables to model the GUI without any coding.

The abovementioned shortcomings, disadvantages and problems are addressed herein and which will be understood by reading and studying the following specification.

### SUMMARY

The primary objective of the embodiments herein is to provide a system and method for exposing the functionalities of a business service, as defined in a service contract through a Graphical User Interface.

Another object is the embodiments herein is to provide a client-platform continuum concept, where the same functional layer can be configured to reside either in the client or in the platform depending on the performance characteristics of the installation.

Another object of the embodiments herein is to develop the frontend without coding, such that non-technical users should also be able to model the GUI to expose the business service functionalities using pre-defined themes, page components and templates.

Another objective of the embodiments herein is to provide a method and system for modelling GUI's without repeating the frontend scripts for different client device types.

These and other objects and advantages of the present embodiments will become readily apparent from the following detailed description taken in conjunction with the accompanying drawings.

The various embodiments of the present method for building a Graphical User Interface (GUI) based front-end for a business service. The method comprises of selecting a user interface (UI) theme for a business solution, selecting a business service contract to be exposed through the GUI, identifying a page template to be used, configuring a page layout to expose functionalities of a business service, selecting a client device type, generating a frontend script for a plurality of client device configurations, testing the frontend scripts through one or more device-specific emulators and storing the generated frontend scripts. The frontend scripts for the plurality of client device configurations are automatically generated without coding using visual modelling tools.

According to an embodiment herein, the method further comprises displaying a GUI based frontend on the client device. Displaying the GUI front end on the client device comprises downloading a User interface (UI) framework by a client device to interact with an enterprise application development platform and executing the UI framework on the client device.

According to an embodiment herein, executing the UI framework on the client device comprises fetching and rendering frontend scripts based on a client device configuration, invoking one or more business services of the application development platform, executing business rules and handling business events.

According to an embodiment herein, a continuum of functional layers between the client and the platform (i.e.) the same functional layer can be configured to reside in either the client or the platform depending on the performance characteristics of the installation.

According to an embodiment herein, the frontend scripts are adapted to be optimized for a common set of form factors.

According to an embodiment herein, the generated frontend scripts is adapted to be modified at runtime thereby enabling to display the front end scripts on client devices with varying form factors.

According to an embodiment herein, the page template is a collection of device specific HTML components and interactions of the HTML components.

According to an embodiment herein, the frontend scripts are adapted to support a plurality of sterility levels of an input business data.

Embodiments herein further provide a system for building a Graphical User Interface (GUI) based front-end for a business service, the system comprising an enterprise application designer, a plurality of client devices and an UI framework installed in each of the plurality of client devices. The enterprise application designer herein is adapted to select a user interface (UI) theme for a business solution, select a business service contract to be exposed through the GUI, identify a page template to be used, configure a page layout to expose functionalities of a business service, select a client device type and generate a frontend script for configuration of a plurality of client devices. The UI framework is adapted to interact with the enterprise application development platform through a web socket to fetch frontend scripts for a chosen page corresponding to a client device configuration invoke business services of the enterprise application development platform to fetch business data and to execute business transactions, interact with a rule engine and an event framework present in the enterprise application development platform, hold temporary data in a session-specific cache and store frontend scripts in the client device.

According to an embodiment herein, the Enterprise Application Designer is adapted to provide an emulator for the plurality of client devices to test the created GUI.

According to an embodiment herein, the UI framework comprises a rule engine adapted for executing business rules and an event manager adapted for managing the business events.

According to an embodiment herein, the system further comprises a Rendering Application installed in the plurality of client devices to execute the UI Framework, wherein the Rendering Application is adapted to display device-specific HTML 5 output produced by the UI Framework, support local storage of the generated frontend scripts and versioning of the frontend scripts.

According to an embodiment herein, the enterprise application development platform comprises a knowledge base to track the characteristics of the client devices that are commonly accessing business services exposed by the platform. Based on this information, the frontend for the specific client devices and form factor is also generated and stored.

According to an embodiment herein, the script-based UI Framework is executed on the client side to interact with the enterprise application development platform. The UI framework is responsible for fetching the frontend scripts, invoking business services and displaying the GUI on the client device.

According to an embodiment herein, the UI Framework comprises a lightweight rule engine and event framework. This framework to handle simple validation and derivation rules on business data in the client side directly. The client is also capable of raising events when certain specific actions are executed.

According to an embodiment herein, a rendering application is installed on specific devices such as mobiles, tablets etc. The Rendering Application is downloaded from the enterprise application development platform to the client device. A Local storage is provided as an additional feature of the rendering application to improve performance where the local storage holds frontend scripts for that client device and form factor and render the scripts with device-specific look and feel. The rendering application also offers versioning support.

The embodiments herein further enables the user to specify multiple client devices, form factors, browser software and the like on which the front end is to be executed. The frontend for the client type is automatically generated from the graphical user interface modeling information and stored in the application platform.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 is a block diagram illustrating to client-platform continuum concept, according to an embodiment of the present disclosure.

FIG. 2 is a flow diagram illustrating a process for building a GUI frontend for a business service using an Enterprise Application Designer according to an embodiment of the present disclosure.

FIG. 3 is a flow diagram illustrating a process involved in displaying a frontend on a client device, according to an embodiment of the present disclosure.

FIG. 4 is a flow diagram illustrating the operations to be performed during a business service invocation, according to an example illustration of the present invention.

Although the specific features of the present embodiments are shown in some drawings and not in others. This is done for convenience only as each feature may be combined with any or all of the other features in accordance with the present embodiments.

### DETAILED DESCRIPTION OF THE DRAWINGS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

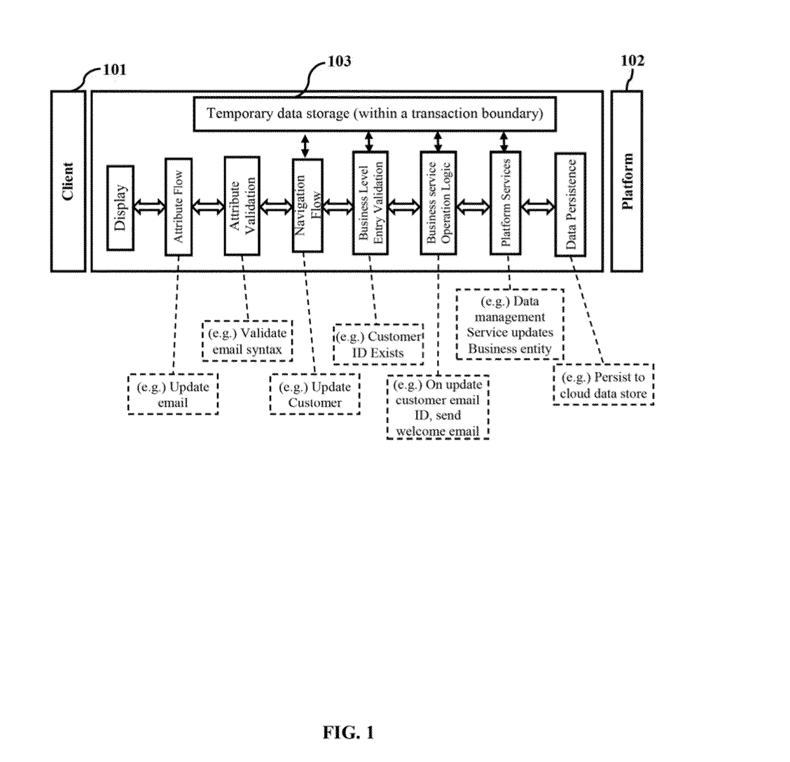

FIG. 1 is a block diagram illustrating to client-platform continuum concept, according to an embodiment of the present disclosure. The platform exposes business services which have been architected using the SOA paradigm. The client will connect to the platform and serves as a GUI for exposing the business service functionality to the user. There will be a continuum of functional layers between the client and the platform (i.e.) the same functional layer can be configured to reside in either the client or the platform depending on the performance characteristics of the installation.

The client-platform continuum herein comprises a display, an attribute flow, attribute validation, navigation flow, business entity level validation, business service operation logic, platform services, data and persistence. The client-platform continuum discloses that different functional layers can reside either in the platform side (server with business services architected using SOA principles) or in the client side (typically a browser but can also be a thick client). This decision as to where a particular functional layer should reside (client or server) depends on the performance characteristics of the client and the platform.

The display is a functional layer which renders the business services using the GUI. The display layer always resides in the client. The attribute flow layer determines the attributes of an entity that are to be displayed using the GUI. The attribute layer can reside in the client side (i.e.) client decides which attribute's have to be fetched from the platform side. Alternatively, the layer can also reside on the platform side (i.e.) client is a dumb display-only terminal. The attribute validation layer validates an attribute once its values have been filled in by the user. The validation occurs in the client and the validated data (sterile data) is sent back to the platform. Alternatively, the non-sterile data is sent to the platform and the platform then performs the necessary validations.

The functional layer of navigation flow determines the sequence of steps to be undertaken to complete a particular action. For instance, while updating an entity, after the attribute values of that entity have been filled in and validated, the next step is to invoke the appropriate business service with the correct parameters. This logic also reside in the client (i.e.) client is aware of which business service to be invoked and the invocation parameters. Alternatively, it the logic also resides in the platform and client just passes the information back to the platform.

The business entity level validation layer determines some higher order validations that need to be performed. For instance, the customer id should be unique is a higher order validation at the entity level. Such higher order validations then reside in the client or the platform. The business service operation logic layer holds the operational logic to be executed when a business service is invoked. For instance, once a customer is created, a welcome email needs to be sent. This layer typically resides in the platform. Only in some special cases, this layer is moved to the client.

The platform services herein comprise core platform services such as data management, business process management, data analytics etc. This layer resides in the platform always. The data persistence layer resides in the platform and is adapted to store the final data after transaction processing is completed. This layer also resides in the platform.

According to an embodiment herein, these functional layers can be configured to reside in either the client or the platform depending on the performance characteristics of the installation. As more and more layers are added to the client, the client becomes more functional (thicker), reducing the processing capacity required by the platform.

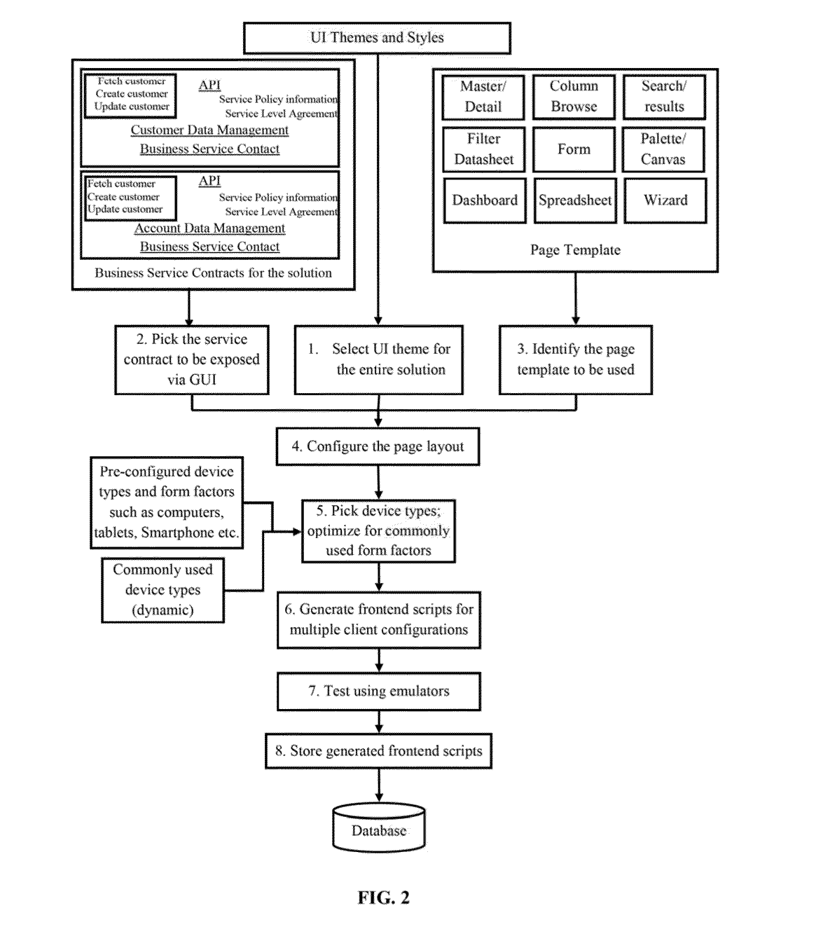

FIG. 2 is a flow diagram illustrating a process for building a GUI frontend for a business service using an Enterprise Application Designer according to an embodiment of the present disclosure. The user first selects an UI theme and styles to be used. Typically the theme selection is made for the entire business solution and all pages of a particular solution share the same theme. The user then selects the business service to be exposed via a GUI. The business contract generally comprises metadata information about a particular business service such as the API of the business service such as exposed methods, inputs, outputs, errors etc., a service policy, a service level agreement, and the like.

Based on the business service, the user selects a page template to visually expose the business service. A page template is a collection of device specific HTML components and their interactions. The layout and interactions of these HTML components in a specific page can be configured by the user.

An enterprise application designer provided on the enterprise application development platform comprises a pre-built set of device types such as browser software, desktop/mobile/tablet etc. The enterprise application development platform further comprises a Knowledge Base for dynamically tracking the common client configurations. The user can select the client configurations for which the frontend scripts should be generated for the configured page.

The Knowledge base also tracks the common form factors of the client configurations. The generated frontend scripts are then optimized based on the common form factors. The generated frontend scripts can be modified at runtime by a Rendering Application to render the frontend scripts on client devices with other form factors as well.

For each client configuration the frontend script is automatically generated by the Enterprise Application Designer. The user can test the generated scripts in device-specific emulators that are bundled with the Enterprise Application Designer.

The tested frontend scripts are finally stored in the enterprise application development platform. When the frontend scripts are requested, the previously generated scripts for a particular client configuration are provided by an enterprise application development platform server.

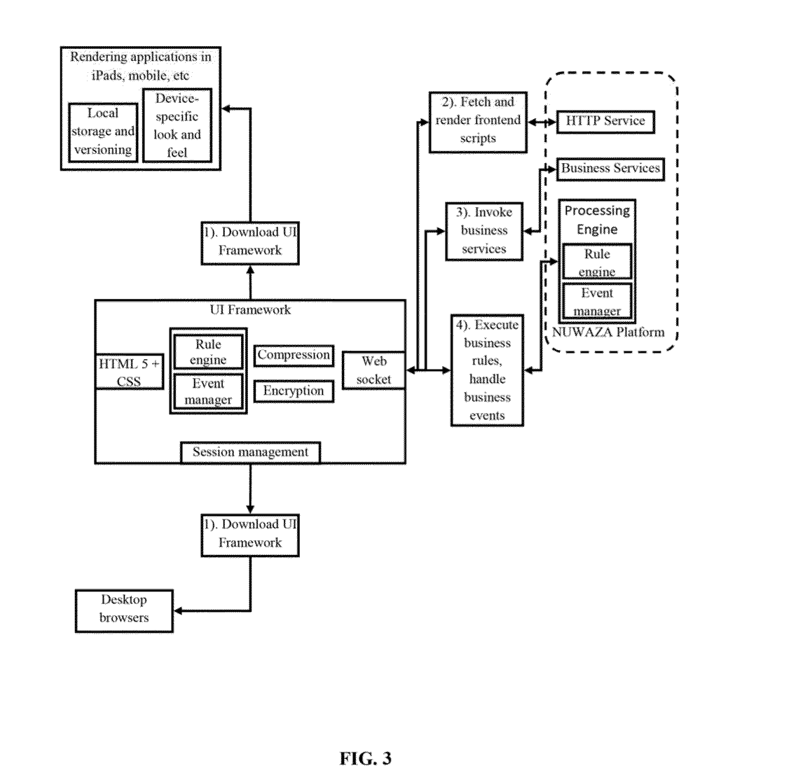

FIG. 3 is a flow diagram illustrating a process involved in displaying a GUI frontend on a client device, according to an embodiment of the present disclosure.

The method comprises of downloading a script-based UI framework by a client device to interact with the enterprise application development platform.

According to an embodiment herein, the UI Framework comprises the following features. The UI framework is adapted to interact with the enterprise application development platform via a web socket, has the ability to encrypt/decrypt messages and handle compression/decompression of messages received from the enterprise application development platform, has session management capability and holds temporary data in a session-specific cache. The UI framework comprises a lightweight Rule Engine and an Event Manager embedded in it for execution of business rules and raise/respond to events.

The UI framework is further adapted to generate the HTML 5+CSS as output for the UI components to be displayed, use the local storage features offered by HTML 5 to store frontend scripts in the client-side.

When the UI Framework is executed on a client device, it enables the client device to interact with the Nuwaza Platform Server to fetch the frontend scripts for the chosen page corresponding to the current device configuration. Further the UI framework invokes the business services of the application development platform to fetch business data, execute business transactions and the like. The UI framework also enables the client device to interact with the rule engine and event framework present in the application development platform.

The Rendering Application comprises a local storage to hold the UI Framework and frontend scripts for the client device and form factor. It will have the ability to execute the UI Framework and display the HTML 5+CSS provided by the UI Framework using a device-specific look and feel (i.e.) the display is conformed to the device's form factors.

The Rendering Application will also support versioning. When the Rendering Application is launched, it executes the steps of checking, with the server if a new version of frontend scripts for a particular client type is available or not, if a new version is available, then download and store the frontend scripts corresponding to the latest version and display the scripts with a look and feel that is device-specific and tailored to its form factors.

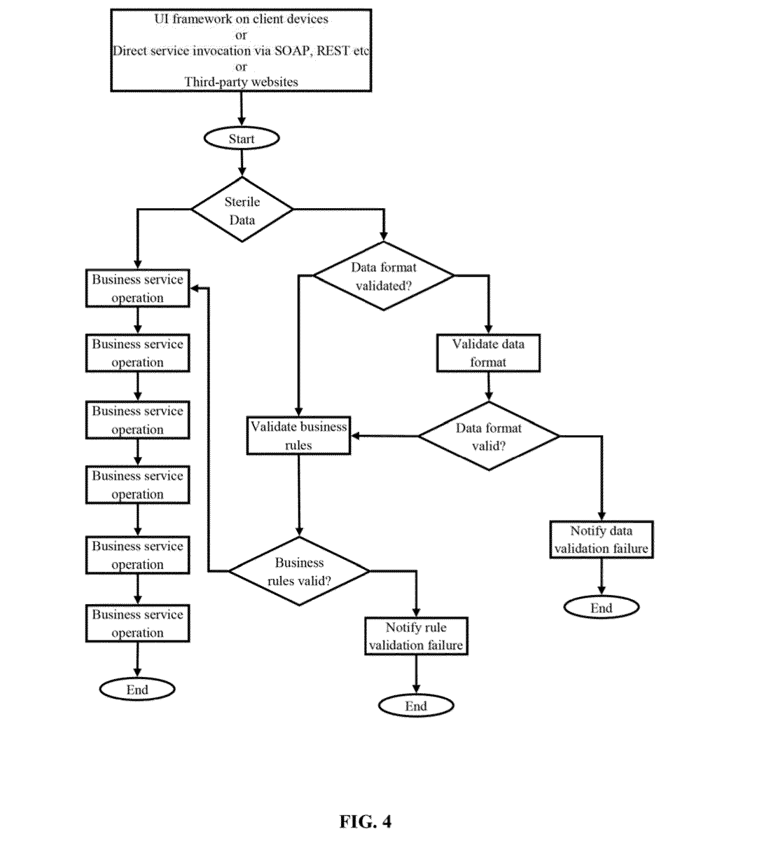

FIG. 4 is a flow diagram illustrating the operations to be performed during a business service invocation based on a sterility level of input business data, according to an example illustration of the present invention. The enterprise application development platform supports multiple levels of sterility in input business data.

According to a first embodiment, the GUI-based frontend is adapted to perform data validations directly. The frontend invokes associated business service while signaling that the data is sterile and has been validated. The data is then signed by the client to assure the application development platform of its integrity. Here, as the business data is validated in the frontend itself, the business service proceeds with the actual service execution directly.

If the frontend has not validated the data, or if the data is coming directly from an external system, the business service is then invoked with a non-sterile data. The business service then validates the data itself before proceeding with the execution.

According to an embodiment herein, the business data that is sent as input to the application development platform comprises different levels of sterility. As an illustration, the different levels of sterile data comprises a non-sterile data where no validations or checks are performed, data where data formats have been validated (i.e.) account balance is a positive integer, customer name should be a string with maximum 40 characters etc and data where business rule validations have already been performed at the business data. These include primary key validations, business rule validations etc.

Based on the sterility of the input business data, the operations to be performed during a business service invocation varies as illustrated by FIG. 4. The input data with high levels of sterility is executed much faster as the validations are already performed on the client side. This will result in significant performance improvements.

The embodiments herein support multiple levels of sterility in input business data. According to an embodiment herein, if the GUI-based frontend is able to perform data validations directly, it will invoke associated business service while signalling that the data is sterile and has been validated. The data will be signed by the client to assure the application platform of its integrity. In this case, since business data is validated in the frontend itself, the business service will proceed with the actual service execution directly.

Alternatively, if the frontend has not validated the data, or if the data is coming directly from an external system, the business service will be invoked with non-sterile data. The business service will then have to validate data itself before proceeding with the execution.

According to an embodiment herein, the business data that is sent as an input to the application platform have different levels of sterility. The different levels of sterile data include a non-sterile data where no validations or checks have been performed, the data where data formats have been validated (i.e.) account balance should be a positive integer, customer name should be a string with maximum 40 characters etc, and data where business rule validations have already been performed on the business data such as primary key validations, business rule validations etc.

Further to improve performance, the sterility level of the input business data from the client can be increased (i.e.) many validation checks is performed upfront on the client side. Since the Rule Engine on the UI Framework is in communication with the Nuwaza Rule Engine, the Nuwaza Rule Engine demarcates certain validation rules to be performed by the client-side lightweight rule engine.

The embodiments herein provide a GUI modeling and development capabilities for an enterprise application development platform. The application development platform provides a set of tools to business users for collaborative development, deployment, execution and maintenance of enterprise applications either on the cloud or standalone.

The embodiments of the present disclosure enables business users/non-technical users to build an enterprise application by wiring platform services with business rules rule-based wiring to build the business services and business processes needed for the enterprise application.

The embodiments of the present disclosure enable the user to develop a GUI-based frontend for any business service contract. The GUI can be associated with any business service authored from the enterprise application development platform and exposes the functionalities of the business service contract.

The user is able to model the GUI using an authoring tool termed as Enterprise Application Designer. The Enterprise Application Designer allows non-technical users to model the GUI without coding using visual modeling tools. The process of modeling the GUI using the Enterprise Application Designer comprises of choosing a UI theme, selecting a page template and finally configuring the page layout to expose the functionalities of the business service. The Enterprise Application Designer provides emulators through which the users can test the look and feel of the GUI for different client devices such as mobile phones, tablets and the like.

The embodiments herein enable a user to specify multiple client devices, form factors, browser software and the like on which the frontend should be executed. The frontend for the client types is then automatically generated from the GUI modelling information stored in the enterprise application development platform.

According to an embodiment herein, the frontend is adapted to support different levels of sterility of input business data. Based on the sterility level of the input business data, the business service execution chooses to skip some redundant data validation checks. This in turn improves the performance of the business services that are executed in the enterprise application development platform.

The foregoing description of the specific embodiments will so fully reveal the general nature of the embodiments herein that others can by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification.

What is claimed is:

1. A method for building a Graphical User Interface (GUI) based front-end for a business service, the method comprises of:
selecting a user interface (UI) theme for a business solution;
selecting a business service contract to be exposed through the GUI;
identifying a page template to be used;
configuring a page layout to expose functionalities of a business service;
selecting a client device type;
generating a frontend script for a plurality of client device configurations;
testing the frontend scripts through one or more device-specific emulators; and
storing, the generated frontend scripts;
wherein the frontend scripts for the plurality of client device configurations are automatically generated without coding using visual modelling tools.

2. The method of claim 1, further comprising providing a continuum of functional layers between a client and a platform, wherein a single functional layer is adapted to be configured to reside in at least one of the client or the platform depending on the performance characteristics of installation.

3. The method of claim 1, further comprising displaying a GUI based front-end on the client device comprising:
downloading a user interface (UI) framework by a client device to interact with an enterprise application development platform; and
executing the UI framework on the cheat device, wherein executing the UI framework comprises:
fetching and rendering frontend scripts based on a client device configuration;
invoking one or more business services of the application development platform executing business rules; and
handling business events.

4. The method of claim 1, wherein the generated frontend scripts is adapted to be optimized for a common set of form factors.

5. The method of claim 1, wherein the generated frontend scripts is adapted to be modified at runtime thereby enabling to display the front end scripts on client devices with varying form factors.

6. The method of claim 1, wherein the page template is a collection of device specific HTML components and interactions of the HTML components.

7. The method of claim 1, wherein the frontend scripts is adapted to support a plurality of sterility levels of an input business data, where the different levels of sterile data comprises of a:
non-sterile data where no validation checks is performed;
a data where data formats are validated; and
data where business rule validations are performed on the business data.

8. A system for building a Graphical User Interface (GUI) based from-end for a business service, the system comprising:
an enterprise application designer adapted to:
select a user interface (UI) theme for a business solution;
select a business service contract to be exposed through the GUI;
identify a page template to be used;
configure a page layout to expose functionalities of a business service;
select a client device type; and
generate a frontend script for configuration of a plurality of client devices;
an UI framework installed in each of the plurality of client devices, wherein the UI framework is adapted to:
interact with the enterprise application development platform through a web socket to fetch frontend scripts for a chosen page corresponding to a client device configuration;
invoke business services of the enterprise application development platform to fetch business data and to execute business transactions;
interact with a rule engine and an event framework present in the enterprise application development platform;
hold temporary data in a session-specific cache; and
store frontend scripts in the client device.

9. The system of claim 8, wherein the Enterprise Application Designer is adapted to provide an emulator for the plurality of client devices to test the created GUI.

10. The system of claim 8, wherein the UI framework comprises:
a rule engine adapted for executing business rules; and
an event manager adapted for managing the business events.

11. The system of claim 8, further comprising a Rendering Application installed in the plurality of client devices to execute the UI Framework, wherein the Rendering Application is adapted to:
display device-specific HTML 5 output produced by the UI Framework;
support local storage of the generated frontend scripts; and
versioning of the frontend scripts.

12. The system of claim 8, wherein the frontend scripts is adapted to support a plurality of sterility levels of an input business data, where the different levels of sterile data comprises of a:
non-sterile data where no validation checks is performed;
a data where data formats are validated; and
data where business rule validations are performed on the business data.
